(19) United States
(12) Patent Application Publication
(10) Pub. No.: US 2021/0336463 A1
(43) Pub. Date: Oct. 28, 2021

(54) STAND-ALONE OPERATION CONTROL SYSTEM

(71) Applicant: Toshiba Misubishi Electric Industrial Systems Corporation, Chuo-ku, Tokyo (JP)

(72) Inventor: Kenta YAMABE, Tokyo (JP)

(73) Assignee: Toshiba Mitsubishi Electric Industrial Systems Corporation, Chuo-ku, Tokyo (JP)

(21) Appl. No.: 16/954,021

(22) PCT Filed: May 14, 2019
(86) PCT No.: PCT/JP2019/019119

§ 371 Date: Jun. 15, 2020

(51) Int. Cl. H02J 7/00

(52) U.S. Cl. CPC H02J 7/0063; H02M 7/44; H02J 7/0048

(57) ABSTRACT

A system including a controller that continuously receives a SOC correlation value of a battery. The controller transmits an open/close signal of a first pattern to a plurality of switches during a period in which a stand-alone operation is being executed and the SOC correlation value is higher than a first threshold value. The controller transmits an open/close signal of a second pattern to the plurality of switches during a period in which the stand-alone operation is being executed and the SOC correlation value is equal to or lower than the first threshold value and higher than a second threshold value that is lower than the first threshold value. The number of load connections according to the open/close signal of the second pattern is fewer than the number of load connections according to the open/close signal of the first pattern and is equal to or more than 1.

### FIELD

The present disclosure relates to a stand-alone operation control system for an inverter device.

### BACKGROUND

PTL 1 discloses a power conversion device whose DC side is connected to a battery and whose AC side is interconnected to a power system. The power conversion device switches, when an abnormality occurs in the power system, its operation state from an interconnected operation state of being interconnected with the power system to a stand-alone operation state of being paralleled off from the power system. In the stand-alone operation state, the power conversion device supplies battery power to loads.

### CITATION LIST

### Patent Literature

[PTL 1] JP 2019-041547A

### SUMMARY

### Technical Problem

However, the power conversion device described in PTL 1 supplies, in the stand-alone operation state, battery power to all loads. Therefore, when the remaining capacity of a battery is insufficient, power supply to an important load cannot be continued for a long time.

The present disclosure has been made in order to solve the above-mentioned problem. It is an object of the present disclosure to provide a stand-alone operation control system that allows power supply to an important load to be continued for a long time in a stand-alone operation state.

### Solution to Problem

A stand-alone operation control system according to the present disclosure includes: an upper level circuit breaker connected to a power system; a lower level circuit breaker connected to the upper level circuit breaker; an inverter connected to the lower level circuit breaker; a battery connected to the inverter; an electric wire whose one end is connected between the upper level circuit breaker and the lower level circuit breaker; a plurality of switches connected in parallel to the other end of the electric wire; a plurality of loads connected to each of the plurality of switches; and a controller configured to transmit an open signal to the upper level circuit breaker and a close signal to the lower level circuit breaker, thereby allowing execution of a stand-alone operation of supplying power from the battery to the plurality of loads. The controller continuously receives a SOC correlation value of the battery and transmits, during a period in which the stand-alone operation is being executed and the SOC correlation value is higher than a first threshold value, an open/close signal of a first pattern to the plurality of switches, thereby electrically connecting two or more loads out of the plurality of loads to the inverter; and transmits, during a period in which the stand-alone operation is being executed and the SOC correlation value is equal to or lower than the first threshold value and higher than a second threshold value that is lower than the first threshold value, an open/close signal of a second pattern to the plurality of switches, thereby electrically connecting loads, which are fewer than the number of load connections according to the open/close signal of the first pattern and are one or more out of the plurality of loads, to the inverter.

Preferably, the open/close signal of the first pattern is transmitted to the plurality of switches, thereby electrically connecting two or more loads in order of priority out of the plurality of loads to the inverter. In addition, the open/close signal of the second pattern is transmitted to the plurality of switches so as to electrically connect one or more loads in order of priority out of the plurality of loads to the inverter.

### Advantageous Effects of Invention

According to the present disclosure, the number of loads to be connected to the inverter can be changed according to the SOC (State Of Charge) correlation value of the battery in the stand-alone operation state. Therefore, in the stand-alone operation state, power supply to an important load can be continued for a long time.

### BRIEF DESCRIPTION OF DRAWINGS

FIG. 1 is a view for explaining the configuration of a stand-alone operation control system in a first embodiment of the present disclosure.

FIG. 2 is a view for explaining functions of a site controller in the first embodiment of the present disclosure.

FIG. 3 is a view showing one example of an open/close pattern table in the first embodiment of the present disclosure.

FIG. 4 is a view for explaining a load connection state in a case where a first pattern is selected in the first embodiment of the present disclosure.

FIG. 5 is a view for explaining a load connection state in a case where a second pattern is selected in the first embodiment of the present disclosure.

FIG. 6 is a view for explaining a load connection state in a case where a third pattern is selected in the first embodiment of the present disclosure.

FIG. 7 is a flowchart for explaining a control routine in a stand-alone operation executed by the site controller in the first embodiment of the present disclosure.

FIG. 8 is a conceptual diagram showing a hardware configuration example of a processing circuit of the site controller in the first embodiment of the present disclosure.

### DESCRIPTION OF EMBODIMENTS

Embodiments of the present disclosure will be described with reference to attached drawings. It should be noted that in the drawings, identical or corresponding parts are denoted by the same reference signs. Repeated explanation of such parts is appropriately simplified or omitted.

### First Embodiment

### (Overall Configuration)

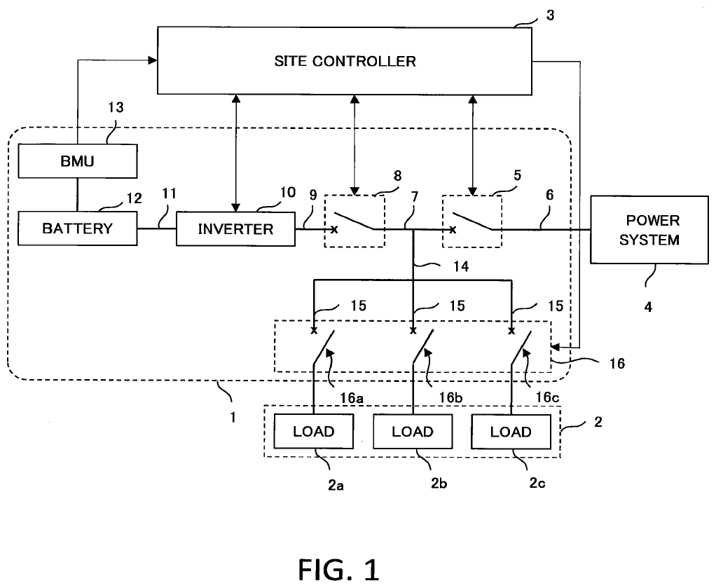

FIG. 1 is a view for explaining a stand-alone operation control system in a first embodiment of the present disclosure.

In FIG. 1, the stand-alone operation control system includes a power conditioner package 1, a plurality of loads 2, and a site controller 3.

The power conditioner package 1 including an inverter device is connected to a power system 4. One end of an upper level circuit breaker 5 is connected to the power system 4 via an electric wire 6. One end of a lower level circuit breaker 8 is connected to the other end of the upper level circuit breaker 5 via an electric wire 7. An AC side of an inverter 10 is connected to the other end of the lower level circuit breaker 8 via an electric wire 9. A battery 12 is connected to a DC side of the inverter 10 via an electric wire 11. As a type of the battery, a large capacity battery such as a lithium ion battery, sodium-sulfur battery, nickel hydride battery, or the like is preferable. It should be noted that the “electric wire” means a power electric wire that serves the function of transmitting electric energy.

The battery 12 is connected to a BMU (Battery Management Unit) 13. The BMU 13 monitors the state of the battery 12. Specifically, the BMU 13 includes, as means for measuring the state quantity of the battery 12, a current sensor (not illustrated), a voltage sensor (not illustrated), and a temperature sensor (not illustrated). Monitoring of the battery 12 by the BMU 13 is performed all the time. It should be noted that “monitoring all the time” mentioned in the present embodiment is a concept including not only the operation of capturing constant continuous signals from the sensors but also the operation of capturing signals of the sensors at a predetermined short cycle. The BMU 13 transmits storage battery information including information obtained by measurement with the sensors, to the site controller 3.

One end of an electric wire 14 is connected to the electric wire 7 between the upper level circuit breaker 5 and the lower level circuit breaker 8. The other end of the electric wire 14 is connected to a plurality of electric wires 15 which are branched in parallel. Each of a plurality of switches 16 is connected to each of the branched plurality of electric wires 15. That is, the plurality of switches 16 are electrically connected in parallel to the other end of the electric wires 14. In an example shown in FIG. 1, the plurality of switches 16 include a first switch 16a, a second switch 16b, and a third switch 16c.

Each of the plurality of loads 2 is connected to each of the plurality of switches 16. In the example shown in FIG. 1, a first load 2a is connected to the first switch 16a. A second load 2b is connected to the second switch 16b. A third load 2c is connected to the third switch 16c.

Each of the plurality of loads 2 includes a load having a different priority. The first load 2a is a load having a highest priority. The first load 2a is a load required for system maintenance, for example, such as the site controller and the BMU. The second load 2b is a load having a highest priority next to the first load 2a. The second load 2b is a load required for operations, for example, such as a general-purpose computer in a factory. The third load 2c is a load having a priority lower than that of the second load 2b. The third load 2c is, for example, a lighting facility in a factory, or the like.

### (Site Controller)

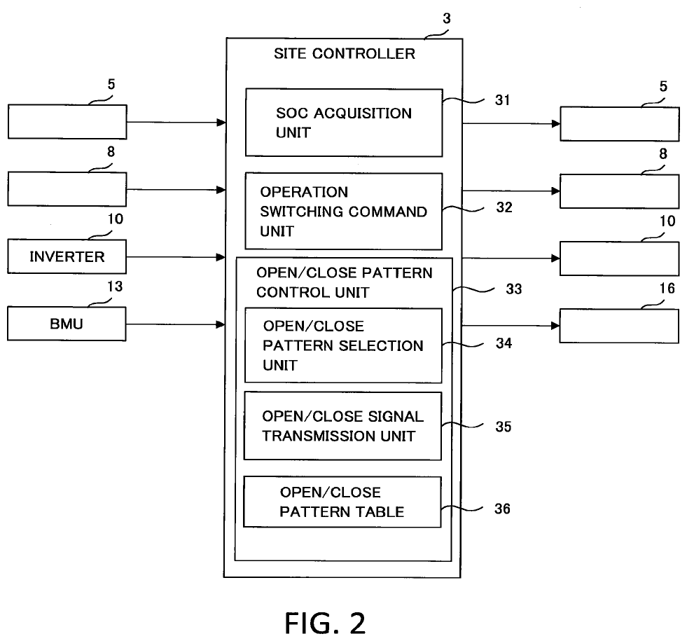

Next, with reference to FIG. 2, functions of the site controller 3 in the present embodiment will be described.

The site controller 3 is connected to the upper level circuit breaker 5, the lower level circuit breaker 8, the inverter 10, the BMU 13, and the plurality of switches 16 via signal lines.

The site controller 3 monitors the open/close state of the upper level circuit breaker 5. In addition, the site controller 3 transmits an open/close signal to the upper level circuit breaker 5 in response to a command from an external energy management system (not illustrated) or an operator's operation. According to the open/close signal, the upper level circuit breaker 5 switches its open/close state.

The site controller 3 monitors the open/close state of the lower level circuit breaker 8. In addition, the site controller 3 transmits an open/close signal to the lower level circuit breaker 8 in response to a command from the external energy management system or an operator's operation. According to the open/close signal, the lower level circuit breaker 8 switches its open/close state.

The site controller 3 monitors the operation state of the inverter 10. In addition, the site controller 3 transmits a command value of active power P[W] and a command value of reactive power Q[var] to the inverter 10.

In addition, the site controller 3 includes a SOC acquisition unit 31, an operation switching command unit 32, and an open/close pattern control unit 33.

The SOC acquisition unit 31 continuously receives storage battery information from the BMU 13. The storage battery information includes an SOC correlation value. The SOC correlation value is, for example, an estimated SOC [%], battery remaining capacity [Ah], or voltage value [V]. In the present embodiment, description will be made on the assumption that the SOC correlation value is SOC [%].

The operation switching command unit 32 switches between an interconnected operation mode and a stand-alone operation mode based on a manual switching command, a switching command from an external EMS, or a result of calculation based on various sensor values.

When the power system 4 is in a normal condition, the power conditioner package 1 is operated in the interconnected operation mode. The operation switching command unit 32 transmits a close signal to both the upper level circuit breaker 5 and the lower level circuit breaker 8. In addition, the operation switching command unit 32 transmits a command to operate the inverter 10 in the interconnected operation mode. Further, the operation switching command unit 32 transmits a close signal to the plurality of switches 16. This brings the power conditioner package 1 into the interconnected operation state of being interconnected with the power system 4, causing power to be supplied to all of the loads 2.

When the power system 4 is in an abnormal condition, for example, when a voltage drop or frequency fluctuation is detected in the power system 4, the power conditioner package 1 is operated in the stand-alone operation mode. The operation switching command unit 32 transmits an open signal to the upper level circuit breaker 5 and transmits a close signal to the lower level circuit breaker 8. In addition, the operation switching command unit 32 transmits a command to operate the inverter 10 in the stand-alone operation mode. This brings the power conditioner package 1 into the stand-alone operation state of being paralleled off from the power system 4, causing power discharged from the battery 12 to be supplied to the loads 2. In the stand-alone operation state, the open/close state of the plurality of switches 16 is still controlled by an open/close pattern control unit 33 described later.

The open/close pattern control unit 33 compares, every time a SOC correlation value is received or periodically during the execution of a stand-alone operation, the SOC correlation value with a plurality of threshold values; and according to a result of the comparison, performs control of switching the open/close patterns of the plurality of switches 16.

The open/close pattern control unit 33 transmits, during a period in which the SOC correlation value is higher than a first threshold value, an open/close signal of a first pattern to the plurality of switches 16, thereby electrically connecting two or more loads of the plurality of loads 2 to the inverter 10.

The open/close pattern control unit 33 transmits, during a period in which the SOC correlation value is equal to or lower than the first threshold value and higher than a second threshold value, an open/close signal of a second pattern to the plurality of switches 16, thereby electrically connecting loads, which are fewer than the number of load connections according to the open/close signal of the first pattern and are one or more out of the plurality of loads 2 to the inverter 10. Here, the second threshold value is lower than the first threshold value.

A concrete description will be given. The open/close pattern control unit 33 includes an open/close pattern selection unit 34, an open/close signal transmission unit 35, and an open/close pattern table 36.

The open/close pattern selection unit 34 compares the SOC correlation value with a plurality of threshold values. In the description below, the plurality of threshold values include a first threshold value, a second threshold value lower than the first threshold value, and a third threshold value lower than the second threshold value. One example is that the first threshold value is 75%, the second threshold value is 50%, and the third threshold value is 25%.

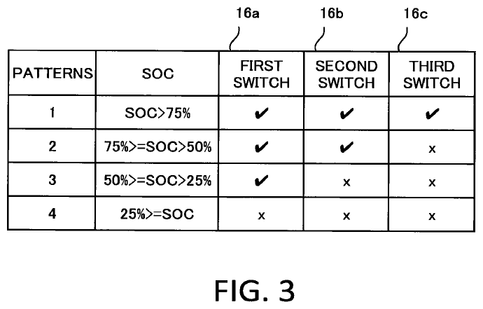

In the open/close pattern table 36, a plurality of open/close patterns for the plurality of switches 16 are predefined. In FIG. 3, definition examples of the open/close patterns are shown.

The open/close pattern selection unit 34 selects, during a period in which the SOC correlation value is higher than 75% (the first threshold value), the first pattern that brings all of the plurality of switches 16 into a closed state.

The open/close pattern selection unit 34 selects, during a period in which the SOC correlation value is equal to or lower than 75% (the first threshold value) and higher than 50% (the second threshold value), the second pattern that brings the first switch 16a and the second switch 16b out of the plurality of switches 16 into a closed state.

The open/close pattern selection unit 34 selects, during a period in which the SOC correlation value is equal to or lower than 50% (the second threshold value) and higher than 25% (the third threshold value), a third pattern that brings only the first switch 16a out of the plurality of switches 16 into a closed state.

The open/close pattern selection unit 34 selects, during a period in which the SOC correlation value is equal to or lower than 25%, a fourth pattern that brings all of the plurality of switches 16 into an open state.

The open/close signal transmission unit 35 outputs an open/close signal to the plurality of switches 16 according to a pattern selected by the open/close pattern selection unit 34.

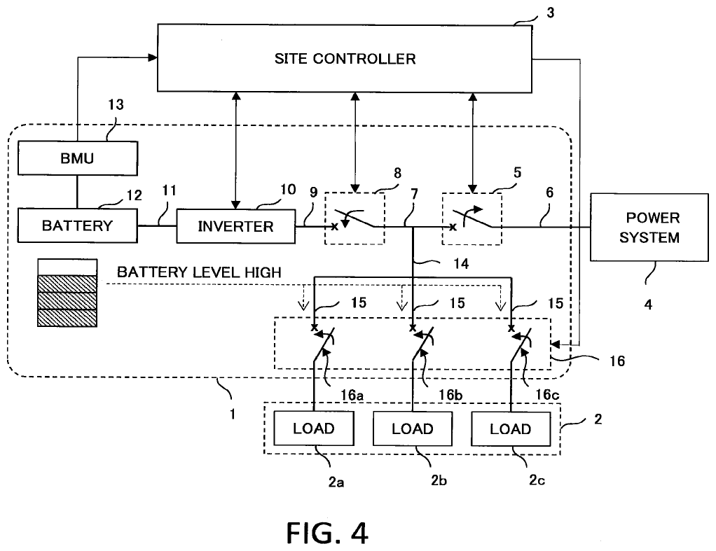

FIG. 4 is a view showing the state of connections between the loads 2 and the inverter 10 in a case where the first pattern is selected. The open/close signal transmission unit 35 transmits a close signal to all of the first switch 16a, the second switch 16b, and the third switch 16c. This causes all of the plurality of loads 2 to be electrically connected to the inverter 10. Therefore, during a period in which the SOC correlation value is higher than 75%, all of the plurality of loads 2 are supplied with power from the battery 12.

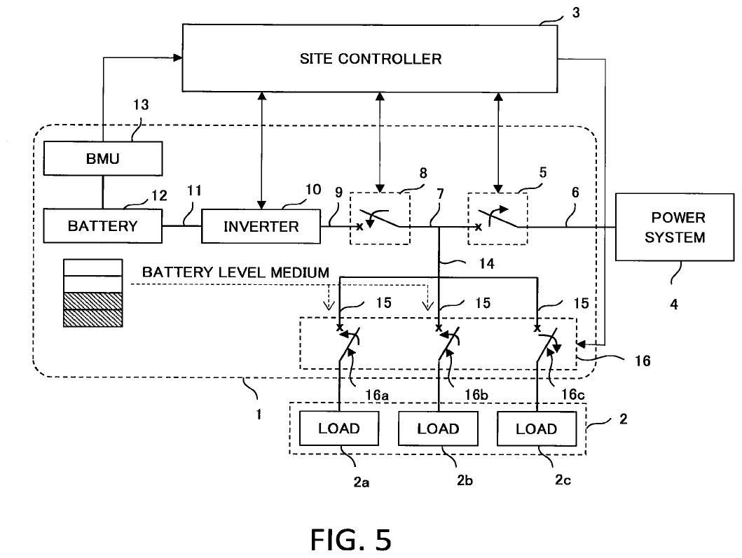

FIG. 5 is a view showing the state of connections between the loads 2 and the inverter 10 in a case where the second pattern is selected. The open/close signal transmission unit 35 transmits a close signal to the first switch 16a and the second switch 16b, and transmits an open signal to the third switch 16c. This causes the first load 2a and the second load 2b having a high priority out of the plurality of loads 2 to be electrically connected to the inverter 10. Therefore, during a period in which the SOC correlation value is equal to or lower than 75% and higher than 50%, the first load 2a and the second load 2b are supplied with power from the battery 12.

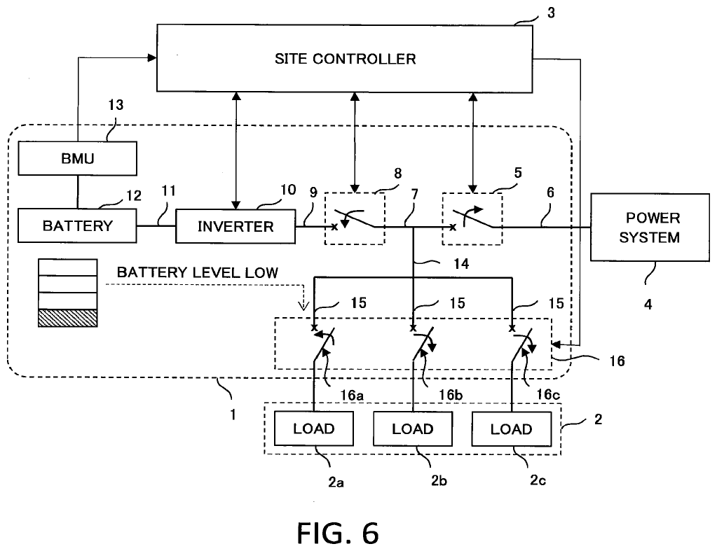

FIG. 6 is a view showing the state of connections between the loads 2 and the inverter 10 in a case where the third pattern is selected. The open/close signal transmission unit 35 transmits a close signal to the first switch 16a and transmits an open signal to the second switch 16b and the third switch 16c. This causes only the first load 2a having a highest priority out of the plurality of loads 2 to be electrically connected to the inverter 10. Therefore, during a period in which the SOC correlation value is equal to or lower than 50% and higher than 25%, the first load 2a is supplied with power from the battery 12.

In addition, when the fourth pattern is selected, the open/close signal transmission unit 35 transmits an open signal to all the first switch 16a, the second switch 16b, and the third switch 16c. This causes any of the plurality of loads 2 to be electrically disconnected from the inverter 10. Therefore, during a period in which the SOC correlation value is equal to or lower than 25%, any of the plurality of loads 2 is not supplied with power from the battery 12.

### (Flowchart)

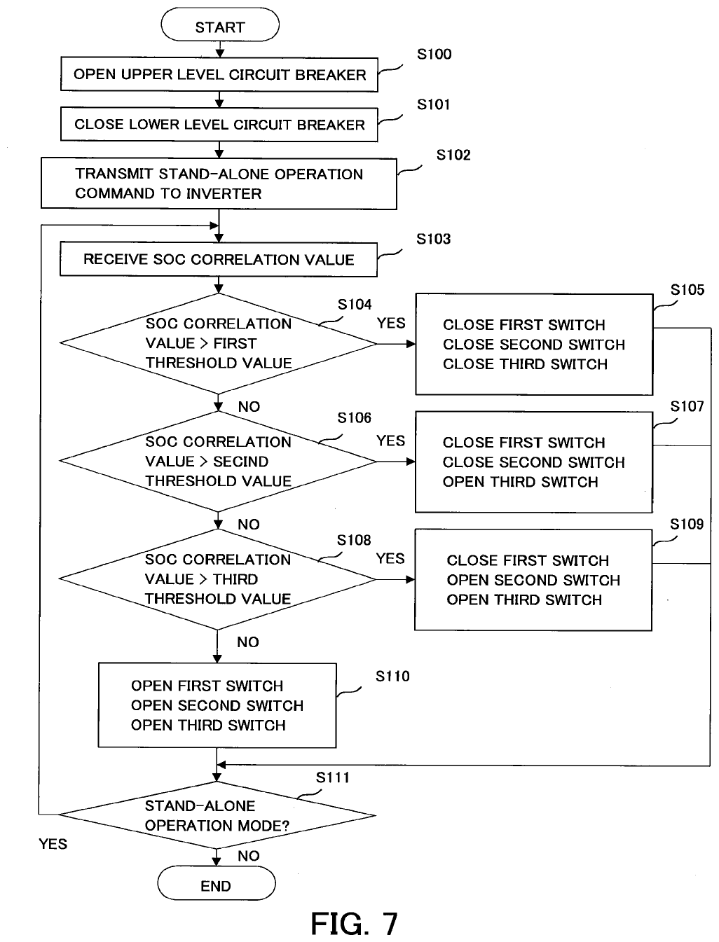

Next, with reference to a flowchart in FIG. 7, a control routine executed by the site controller 3 in the stand-alone operation mode will be described. This control routine is executed in switching from an interconnected operation to a stand-alone operation when an abnormality occurs in the power system 4.

First, at step S100, the site controller 3 transmits an open signal to the upper level circuit breaker 5. The upper level circuit breaker 5 receives the open signal, being brought into an open state. As a result, the power conditioner package 1 is paralleled off from the power system.

At step S101, the site controller 3 transmits a close signal to the lower level circuit breaker 8. The lower level circuit breaker 8 receives the close signal, being brought into a closed state. As a result, a state in which power can be supplied to the plurality of loads 2 from the battery 12 is set.

At step S102, the site controller 3 transmits a stand-alone operation command to the inverter 10. The inverter 10 receives the stand-alone operation command and starts operation using settings for the stand-alone operation mode.

Next, at step S103, the site controller 3 receives a SOC correlation value from the BMU 13.

Next, at step S104, the site controller 3 compares the SOC correlation value with the first threshold value (75%). If the SOC correlation value is higher than the first threshold value, the process proceeds to step S105. On the other hand, if the SOC correlation value is lower than the first threshold value, the process proceeds to step S106.

At step S105, the site controller 3 transmits a close signal to the first switch 16a, the second switch 16b, and the third switch 16c. This causes all of the plurality of loads 2 to be electrically connected to the inverter 10. Therefore, during a period in which the SOC correlation value is higher than 75%, all of the plurality of loads 2 are supplied with power from the battery 12.

At step S106, the site controller 3 compares the SOC correlation value with the second threshold value (50%). If the SOC correlation value is higher than the second threshold value, the process proceeds to step S107. On the other hand, if the SOC correlation value is lower than the second threshold value, the process proceeds to step S108.

At step S107, the site controller 3 transmits a close signal to the first switch 16a and the second switch 16b, and transmits an open signal to the third switch 16c. This causes the first load 2a and the second load 2b having a high priority out of the plurality of loads 2 to be electrically connected to the inverter 10. Therefore, during a period in which the SOC correlation value is equal to or lower than 75% and higher than 50%, the first load 2a and the second load 2b are supplied with power from the battery 12.

At step S108, the site controller 3 compares the SOC correlation value with the third threshold value (25%). If the SOC correlation value is higher than the third threshold value, the process proceeds to step S109. On the other hand, if the SOC correlation value is lower than the third threshold value, the process proceeds to step S110.

At step S109, the site controller 3 transmits a close signal to the first switch 16a, and transmits an open signal to the second switch 16b and the third switch 16c. This causes only the first load 2a having a highest priority out of the plurality of loads 2 to be electrically connected to the inverter 10. Therefore, during a period in which the SOC correlation value is equal to or lower than 50% and higher than 25%, the first load 2a is supplied with power from the battery 12.

At step S110, the site controller 3 transmits an open signal to the first switch 16a, the second switch 16b, and the third switch 16c. This causes any of the plurality of loads 2 to be electrically disconnected from the inverter 10. Therefore, during a period in which the SOC correlation value is equal to or lower than 25%, any of the plurality of loads 2 is not supplied with power from the battery 12.

At step S111, whether or not the stand-alone operation mode is set is determined. If the stand-alone operation mode is set, the process returns to step S103 and continues. Every time the SOC correlation value is received during the execution of a stand-alone operation, processing at and after step S104 is executed. This allows the open/close pattern of the plurality of switches 16 to be changed according to a change of the SOC correlation value, so that power supply to a load having a high priority out of the plurality of loads 2 can be continued for a long time. At step S111, if the stand-alone operation mode is not set, this routine ends.

### (Effect)

As described above, according to the stand-alone operation control system of the present embodiment, the number of loads to be connected to the inverter 10 can be changed according to the SOC correlation value of the battery 12 in the stand-alone operation state. Therefore, in the stand-alone operation state, power supply to a load having a high priority can be continued for a long time. Conversely, selection for never performing the supply to a load having a low priority is possible, allowing the efficient use of a battery power resource. In addition, by changing definitions of the open/close pattern table 36, an additional accommodation to a load configuration is also possible.

In the system of the first embodiment mentioned above, the first threshold value is 75% and the second threshold value is 50%; however, they are not limited thereto. The threshold value may be any value. For example, the first threshold value may be 50% and the second threshold value may be 25%.

In addition, in the system of the first embodiment mentioned above, during a period in which the SOC correlation value is higher than the first threshold value, all of the plurality of loads 2 are connected to the inverter 10; however, they are not limited thereto. Two loads having a high priority (the first load 2a and the second load 2b) may be connected to the inverter 10. Similarly, during a period in which the SOC correlation value is equal to or lower than the first threshold value and higher than the second threshold value, only a load having a highest priority (the first load 2a) may be connected to the inverter 10.

In addition, the system of the first embodiment mentioned above has been described with a configuration including the three switches 16 and the three loads 2; however, the numbers of switches and loads are not limited thereto. It is only required that each of the numbers of switches and loads is two or more.

### (Hardware Configuration Example)

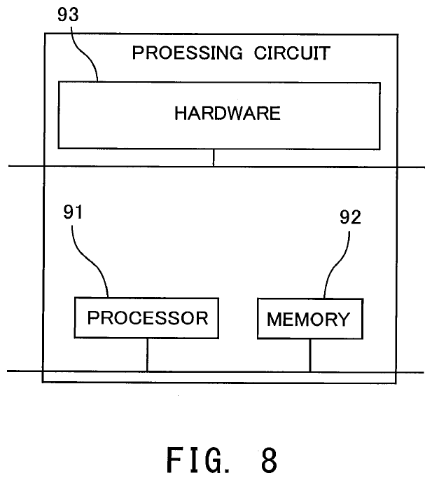

FIG. 8 is a conceptual diagram showing a hardware configuration example of a processing circuit of the site controller 3 mentioned above. Each of the above-mentioned functions is achieved by the processing circuit. As one aspect, the processing circuit includes at least one processor 91 and at least one memory 92. As another aspect, the processing circuit includes at least one dedicated hardware 93.

In a case where the processing circuit includes the processor 91 and the memory 92, each of the functions is achieved by software, firmware, or a combination of software and firmware. At least one of the software and the firmware is described as a program. At least one of the software and the firmware is stored in the memory 92. The processor 91 reads and executes a program stored in the memory 92, thereby achieving each of the functions.

In a case where the processing circuit includes the dedicated hardware 93, the processing circuit is, for example, a single circuit, a composite circuit, a programmed processor, or a combination of them. Each of the functions is achieved by the processing circuit.

Although the embodiment according to the present disclosure has been described above, the present disclosure is not limited to the above embodiment and various modifications can be made without departing from the scope of the present disclosure.

### REFERENCE SIGNS LIST

1 Power conditioner package
2, 2a, 2b, 2c A plurality of loads, First load, Second load, Third load
3 Site controller
4 Power system
5 Upper level circuit breaker
6, 7, 9, 11, 14, 15 Electric wire
8 Lower level circuit breaker
10 Inverter
12 Battery
16, 16a, 16b, 16c A plurality of switches, First switch, Second switch, Third switch
31 SOC acquisition unit
32 Operation switching command unit
33 Open/close pattern control unit
34 Open/close pattern selection unit
35 Open/close signal transmission unit
36 Open/close pattern table
91 Processor
92 Memory
93 Hardware

1. A stand-alone operation control system, comprising:
an upper level circuit breaker connected to a power system;
a lower level circuit breaker connected to the upper level circuit breaker;
an AC side of an inverter connected to the lower level circuit breaker;
a battery connected to a DC side of the inverter;
an electric wire, one end of the electric wire being connected between the upper level circuit breaker and the lower level circuit breaker;
a plurality of switches connected in parallel to another end of the electric wire;
a plurality of loads connected to each of the plurality of switches; and
a controller configured to transmit an open signal to the upper level circuit breaker and a close signal to the lower level circuit breaker, thereby allowing execution of a stand-alone operation of supplying power from the battery to the plurality of loads; wherein
the controller:
continuously receives an SOC correlation value of the battery;
transmits an open/close signal of a first pattern to the plurality of switches during a period in which the stand-alone operation is being executed and the SOC correlation value is higher than a first threshold value, thereby electrically connecting two or more loads out of the plurality of loads to the inverter; and
transmits an open/close signal of a second pattern to the plurality of switches during a period in which the stand-alone operation is being executed and the SOC correlation value is equal to or lower than the first threshold value and higher than a second threshold value lower than the first threshold value, thereby electrically connecting loads to the inverter, the loads being fewer than a number of load connections according to the open/close signal of the first pattern and being one or more out of the plurality of loads.

2. The stand-alone operation control system according to claim 1, wherein
the open/close signal of the first pattern is transmitted to the plurality of switches, and two or more loads out of the plurality of loads are electrically connected to the inverter in order of priority; and
the open/close signal of the second pattern is transmitted to the plurality of switches, and one or more loads out of the plurality of loads are electrically connected to the inverter in order of priority.
